(19) United States
(12) Patent Application Publication
(10) Pub. No.: US 2026/0210819 A1
(43) Pub. Date: Jul. 23, 2026

(54) TESTING METHOD AND TESTING SYSTEM FOR HYDROGEN-INDUCED CRACKING THRESHOLD VALUE BASED ON NOTCHED ROUND BAR TENSILE SPECIMEN

(71) Applicant: Tianjin University, Tianjin (CN)

(72) Inventors: Lianyong Xu, Tianjin (CN); Dong Han, Tianjin (CN); Yongdian Han, Tianjin (CN); Youfu Xiao, Tianjin (CN); Lei Zhao, Tianjin (CN); Kangda Hao, Tianjin (CN)

(73) Assignee: Tianjin University, Tianjin (CN)

(21) Appl. No.: 19/333,325

(22) Filed: Sep. 18, 2025

(30) Foreign Application Priority Data
Jan. 23, 2025 (CN) 202510108168.2

(51) Int. Cl. G01N 3/08

(52) U.S. Cl. CPC G01N 3/08; G01N 2203/0017; G01N 2203/0066; G01N 2203/0075; G01N 2203/027

(57) ABSTRACT

The disclosure belongs to the field of material testing, and a testing method and a testing system for a hydrogen-induced cracking threshold value based on a notched round bar tensile specimen are provided. The testing method comprises: performing the slow strain rate tensile test on the notched round bar specimen respectively in the hydrogen environment and the inert gas environment to obtain the test data and two elongation rates; obtaining a hydrogen embrittlement susceptibility index of material using the two elongation rates; obtaining an elastoplastic parameter using the hydrogen embrittlement susceptibility index of material and the test data; when the elastoplastic parameter is greater than 3.5, obtaining the hydrogen-induced cracking threshold value using an elastoplastic crack growth mechanism; and when the elastoplastic parameter is not greater than 3.5, obtaining the hydrogen-induced cracking threshold value using a linear elastic crack growth mechanism.

### CROSS-REFERENCE TO RELATED APPLICATION

This application claims the priority benefit of China application serial no. 202510108168.2, filed on Jan. 23, 2025, now allowed. The entirety of the above-mentioned patent application is hereby incorporated by reference herein and made a part of this specification.

### BACKGROUND

### Technical Field

The disclosure belongs to the technical field of material testing, and specifically relates to a testing method and a testing system for a hydrogen-induced cracking threshold value based on a notched round bar tensile specimen.

### Description of Related Art

Pipeline hydrogen transportation is currently the primary method for hydrogen energy transmission. However, hydrogen can cause damage to pipeline materials, thereby restricting the improvement of material performance and jeopardizing the safe and stable operation of equipment. Among these issues, hydrogen-induced cracking (HIC) is particularly significant. HIC refers to the phenomenon in which, in a hydrogen environment, metals or alloys are subjected the penetration and accumulation of hydrogen atoms under stress below conventional strength limits, causing the initiation of microcracks within the material. These cracks gradually propagate under sustained stress, ultimately leading to overall fracture of the material. This phenomenon is difficult to predict, and the material property deteriorates rapidly during the fracture process, posing a significant threat to the safe operation of industrial equipment.

In HIC research, the stress intensity factor threshold value K_{IH} is a key parameter tor evaluating the material crack resistance property. The stress intensity factor (K) is a physical quantity that measures the stress concentration at the crack tip, reflecting the driving force for crack propagation. Meanwhile, K represents the minimum stress intensity factor required for the material to resist hydrogen-induced cracking under specific conditions. Once the stress intensity factor at the crack tip exceeds K_{IH}, the crack will propagate, leading to material failure. Therefore, K_{IH} is crucial for ensuring the safety of hydrogen energy transportation equipment.

The conventional methods for measuring K_{IH} include a constant load testing, a slow strain rate testing and a constant displacement testing, among which Double Cantilever Beam (DCB) method and Wedge Opening Loading (WOL) method are most commonly used. The DCB method utilizes specimens with specific geometries to generate the required stress intensity factor for crack initiation and propagation, thereby enabling the measurement of the stress intensity factor threshold value K_{IH}. However, these methods have several limitations: accumulation of the required extensive experimental data, long testing cycle (for pipeline steels, crack arrest often takes weeks to months) and significant variations in test results among different laboratories, resulting in limited repeatability.

### SUMMARY

The disclosure aims to provide a testing method and a testing system for a HIC threshold value based on a notched round bar tensile specimen, aiming to solve the problems of low test efficiency and poor repeatability of test methods for measuring the HIC threshold values.

Specifically, the disclosure provides a testing method for a HIC threshold value based on notched round bar tensile specimens, comprising:
S1: performing a slow strain rate tensile (SSRT) test on the notched round bar tensile specimens in a hydrogen environment to obtain test data, the test data including a yield strength, a tensile strength, a first maximum displacement, an engineering stress, and an engineering strain, obtaining a first elongation rate using the first maximum displacement and an original length of the notched round bar tensile specimens; performing the SSRT test on the same notched round bar tensile specimens in an inert gas environment to obtain a second maximum displacement, and obtaining a second elongation rate using the second maximum displacement and the original length;
S2: obtaining a hydrogen embrittlement susceptibility index of material using the first elongation rate and the second elongation rate; and obtaining an elastoplastic parameter using the hydrogen embrittlement susceptibility index of material, the yield strength and the tensile strength;
S3: determining whether the elastoplastic parameter R is greater than 3.5, if yes, obtaining the HIC threshold value based on an elastoplastic crack growth mechanism; and if no, obtaining the HIC threshold value based on a linear elastic crack growth mechanism.

Further, in the step S2, a formula of the obtained hydrogen embrittlement susceptibility index of material is expressed as:

$${I}_{HE} = \frac{{δ}_{0} - {δ}_{H}}{{δ}_{0}}$$

wherein, I_{HE} is the hydrogen embrittlement susceptibility index of material, δ_{H} is the first elongation rate and δ₀ is the second elongation rate.

Further, a notch stress concentration factor of the notched round bar tensile specimen is 3 or greater.

Further, in the step S2, a formula of the obtained elastoplastic parameter is expressed as:

$$R = 6.32 {I}_{HE} + \frac{{σ}_{NTS}}{{σ}_{y}}$$

wherein, R is the elastoplastic parameter, σ_{y} is the yield strength, σ_{NTS} is the tensile strength and I_{HE} is the hydrogen embrittlement susceptibility index of material.

Further, in the step S3, when the elastoplastic parameter R is not greater than 3.5, the HIC threshold value is obtained using the following formula:

$${K}_{IH} = {P}_{IH} {D}^{0.5} {F}_{1}^{0.5}$$

wherein, K_{IH} is the HIC threshold value, a unit is MPa·m^{0.5}, P_{IH} is a critical load of HIC and F1 is a first geometric function under a linear elastic crack growth mechanism.

Furthermore, the first geometric function is obtained by the following formula:

$${F}_{1} = 22.5 ( \frac{{d}^{2}}{{D}^{4}} ) ( 1 - \frac{d}{D} ) + 3.86 ( \frac{D}{{d}^{3}} ) {( 1 - \frac{d}{D} )}^{2}$$

wherein, D is the original diameter of the notched round bar tensile specimen; and d is a notch diameter of the notched round bar tensile specimen.

Further, in the step S3, when the elastoplastic parameter R is greater than 3.5, the corresponding HIC threshold value is obtained using the following formula:

$${K}_{IH} = \sqrt{\frac{{J}_{IH} {E}_{Y}}{( 1 - {v}^{2} )}}$$

wherein, K_{IH} is the HIC threshold value, a unit is MPa·m^{0.5}, J_{IH} is a J-integral value of HIC, E_{Y} is an elastic modulus of material and ν is a Poisson's ratio.

Furthermore, a calculation formula of the J-integral value of HIC is:

$${J}_{IH} = 0.0021 {F}_{2} ( π {r}_{0}^{2} Δ {lE}_{Y} + {P}_{IH} {l}_{0} )$$

wherein, J_{IH} is the J-integral value of HIC, l₀ is the original length of the notched round bar tensile specimen, r₀ is an original radius of the notched round bar tensile specimen, F₂ is a second geometric function, P_{IH} is the critical load of HIC and Δl is the first maximum displacement.

Furthermore, a calculation formula of the second geometric function is:

$${F}_{2} = \frac{( {l}_{0} + Δ l ) Δ l}{{l}_{0}^{2} {r}^{2}}$$

wherein, F₂ is the second geometric function under an elastoplastic crack growth mechanism, wherein r is a notch radius of the notched round bar tensile specimen.

Furthermore, steps of obtaining the critical load P_{IH} of HIC comprise:
S301: obtaining a true strain and a true stress of the notched round bar tensile specimen using the engineering stress and the engineering strain;
S302: plotting a true stress-true strain curve based on the true strain and true stress to fit the test data; and
S303: obtaining an actual strain ε_{T0} corresponding to a strain hardening rate of 0 based on the fitted test data, and taking a load corresponding to the actual strain ε_{T0} as the critical load P_{IH} of HIC.

Furthermore, in the step S301, a formula of the obtained true stress is:

$${σ}_{T} = σ ( 1 + ε )$$

wherein, σ is the engineering stress, ε is the engineering strain and σ_{T} is the true stress; and/or
in the step S301, a formula of the obtained true strain is:

$${ε}_{T} = ln ( 1 + ε )$$

wherein ε_{T} is the true strain; and/or
in the step S302, the test data is fitted to a fifth-order polynomial; and/or
in the step S303, a method of obtaining the actual strain ε_{T0} is: differentiating the fitted test data and plotting a θ-ε_{T} curve, wherein θ=dσ_{T}/dε_{T}, a strain at the strain hardening rate θ=0 as the true strain ε_{T0}.

More specifically, a testing system is further provided for implementing the testing method according to any one of the preceding claims. The testing system comprises:
a test data acquisition module for obtaining test data after performing the SSRT test on the notched round bar tensile specimen in the hydrogen environment, the test data including the yield strength, the tensile strength, the first maximum displacement, the engineering stress and the engineering strain, and for obtaining the first elongation rate using the first maximum displacement and the original length of the notched round bar tensile specimen; and further for obtaining the corresponding second maximum displacement after performing the SSRT test on the same notched round bar tensile specimen in the inert gas environment, and obtaining the second elongation rate using the second maximum displacement and the original length;
a specimen parameter acquisition module for obtaining the hydrogen embrittlement susceptibility index of material using the first elongation rate and the second elongation rate; and obtaining the elastoplastic parameter R using the hydrogen embrittlement susceptibility index of material, the yield strength and the tensile strength; and
a HIC threshold value acquisition module for determining whether the elastoplastic parameter R is greater than 3.5, if yes, further for obtaining the HIC threshold value based on an elastoplastic crack growth mechanism; and if no, further for obtaining the HIC threshold value based on a linear elastic crack growth mechanism.

The disclosure provides as follows:
1. The testing method provided by the disclosure is more convenient and flexible, has fewer limiting conditions, and has a short test cycle, making it very suitable for testing requirements of metal materials such as pipeline steel. Meanwhile, this testing method performing the SSRT tests under two environments simultaneously on the notched round bar tensile specimens has high material utilization rate, low material cost, simple specimen processing, and easy implementation of the testing method.
2. The testing method provided by the disclosure is based on the SSRT test to investigate fracture mechanical properties. By performing the SSRT test on the same notched round bar tensile specimens under two environments, the test data is obtained to calculate the HIC threshold value, thereby significantly shortening the test cycle. Furthermore, by designing notches in specific regions of the notched round bar tensile specimens, accurate research can be performed on narrow regions such as weld seams of welded joints and heat-affected zones. The obtained test data can also effectively evaluate the hydrogen embrittlement susceptibility of material. The elastoplastic parameter is calculated based on the hydrogen embrittlement susceptibility index of material, and then the HIC threshold value is obtained using the elastoplastic parameter, resulting in more accurate calculation results.
3. The testing method provided by the disclosure is not limited by testing environments and can be applied to calculate HIC threshold value under various conditions, with high repeatability and stronger universality.

### BRIEF DESCRIPTION OF THE DRAWINGS

FIG. 1 is a flowchart of the testing method provided by the embodiment of the disclosure.

FIG. 2 is a processing drawing of the X65 pipeline steel with notched SSRT test provided by the embodiment of the disclosure.

FIG. 3 is a θ-ε_{T} curve diagram provided by the embodiment of the disclosure.

FIG. 4 is a comparison diagram of HIC threshold value for different testing methods provided by the embodiment of the disclosure.

### DESCRIPTION OF THE EMBODIMENTS

In order to make the disclosure clearer and more comprehensible, the disclosure is further described in detail with reference to the drawings and embodiments. It should be understood that the specific embodiments described herein serve to explain the disclosure merely and are not used to limit the disclosure.

In the disclosure, it should be understood that the terms “first” and “second” are only used for descriptive purposes, and cannot be understood as indicating or implying relative importance or implicitly indicating the number of indicated technical features. Thus, the features defined with “first” and “second” may explicitly or implicitly include one or more of these features. In the description of the disclosure, “plurality” means two or more than two, unless otherwise expressly and specifically defined.

Additionally, throughout the disclosure, references to “one embodiment”, “one embodiment”, “an example” or similar language indicates that the specific features, structures or characteristics described in connection with the embodiment are included in at least one embodiment of the disclosure. Therefore, the appearance of the phrase “in one embodiment”; “in one embodiment” and similar language throughout the disclosure may, but do not necessarily, all refer to the same embodiment.

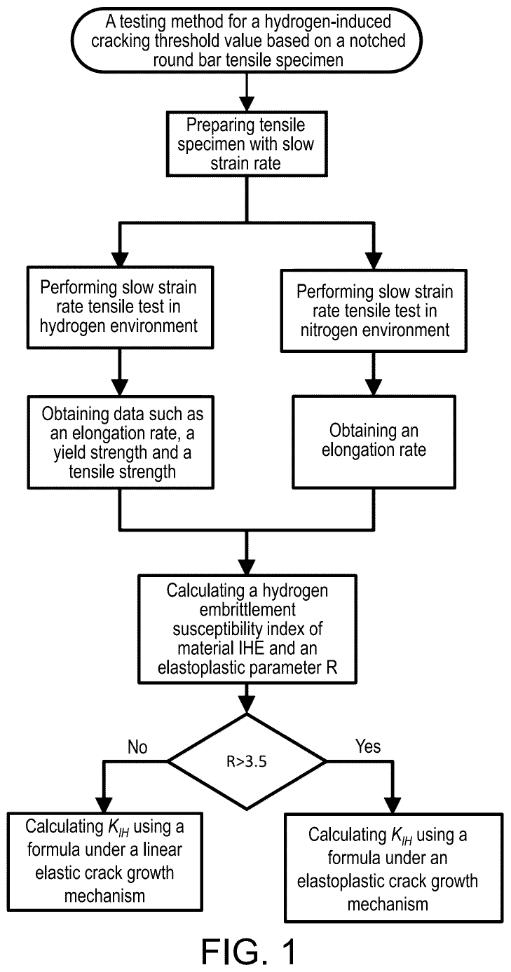

The embodiment of the disclosure provides a testing method for a HIC threshold value based on notched round bar tensile specimens. As shown in FIG. 1, the testing method comprises the following steps.
S1: performing a SSRT test on the notched round bar tensile specimens in a hydrogen environment to obtain test data, the test data including a yield strength, a tensile strength, a first maximum displacement, an engineering stress and an engineering strain, obtaining a first elongation rate using the first maximum displacement and an original length of the notched round bar tensile specimens; performing the SSRT test on the notched round bar tensile specimens in an inert gas environment to obtain a second maximum displacement, and obtaining a second elongation rate using the second maximum displacement and the original length;
S2: obtaining a hydrogen embrittlement susceptibility index of material using the first elongation rate and the second elongation rate; and obtaining an elastoplastic parameter R using the hydrogen embrittlement susceptibility index of material, the yield strength and the tensile strength; and
S3: determining whether the elastoplastic parameter R is greater than 3.5, if yes, obtaining the HIC threshold value based on an elastoplastic crack growth mechanism; and if no, obtaining the HIC threshold value based on a linear elastic crack growth mechanism.

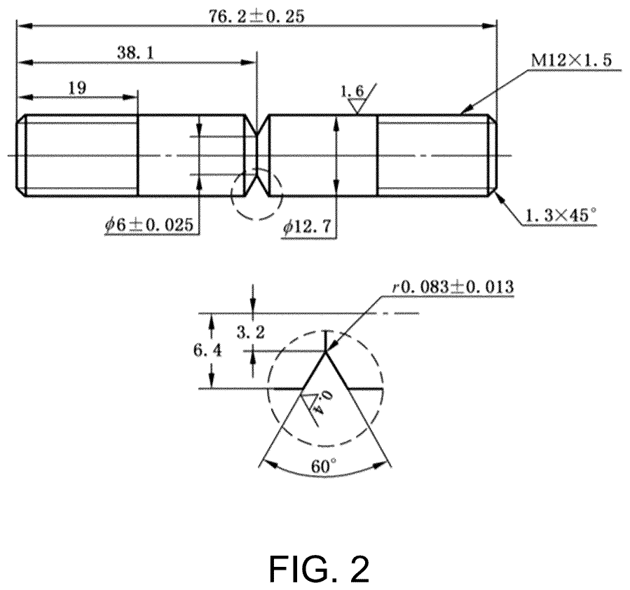

The testing metal material is processed into a standard SSRT notched round bar specimen (hereinafter referred to as specimen) according to the drawing shown in FIG. 2, and the notch stress concentration factor of the specimen is greater than or equal to 3. In the step S1, in a hydrogen environment, the strain rate during testing is 2×10⁻⁶ s⁻¹, the gauge length is 20 mm, the gauge section of the specimen needs to be measured using an extensometer, and the specimen needs to be placed statically in the hydrogen environment for 2 hours at the beginning of the test.

In the step S2, a formula of the obtained hydrogen embrittlement susceptibility index of material is expressed as:

$${I}_{HE} = \frac{{δ}_{0} - {δ}_{H}}{{δ}_{0}} \qquad ( 1 )$$

wherein, I_{HE} is the hydrogen embrittlement susceptibility index of material, δ_{H} is the first elongation rate and δ₀ is the second elongation rate.

A formula of the obtained elastoplastic parameter is expressed as:

$$R = 6.32 {I}_{HE} + \frac{{σ}_{NTS}}{{σ}_{y}} \qquad ( 2 )$$

wherein, R is the elastoplastic parameter, σ_{y} is the yield strength, a unit is MPa, defined as an extension strength at a non-proportional extension rate of 0.2%; σ_{NTS} is the tensile strength, a unit is MPa; and I_{HE} is the hydrogen embrittlement susceptibility index of material.

In the step S3, when R is not greater than 3.5, a formula of the obtained HIC threshold value based on a a linear elastic crack growth mechanism is:

$${K}_{IH} = {P}_{IH} {D}^{0.5} {F}_{1}^{0.5} \qquad ( 3 )$$

wherein, K_{IH} is the HIC threshold value, a unit is MPa·m^{0.5}, P_{IH} is a critical load of HIC, a unit is kN and F1 is a first geometric function under the linear elastic crack growth mechanism.

A calculation formula of the first geometric function is:

$${F}_{1} = 22.5 ( \frac{{d}^{2}}{{D}^{4}} ) ( 1 - \frac{d}{D} ) + 3.86 ( \frac{D}{{d}^{3}} ) {( 1 - \frac{d}{D} )}^{2} \qquad ( 4 )$$

wherein, F1 is the first geometric function under the linear elastic crack growth mechanism, D is the original diameter of the notched round bar tensile specimen, a unit is m; and d is a notch diameter of the notched round bar tensile specimen, a unit is m.

In the step S3, when the elastoplastic parameter R is greater than 3.5, indicating an elastoplastic crack growth mechanism, and a formula of calculating the HIC threshold value is

$${K}_{IH} = \sqrt{\frac{{J}_{IH} {E}_{Y}}{( 1 - {v}^{2} )}} \qquad ( 5 )$$

wherein, K_{IH} is the HIC threshold value, a unit is MPa·m^{0.5}, J_{IH} is a J-integral value of HIC, E_{Y} is an elastic modulus of material and ν is a Poisson's ratio, which is generally taken as 0.3 for metallic materials.

A calculation formula of the J-integral value of HIC is:

$${J}_{IH} = 0.0021 {F}_{2} ( π {r}_{0}^{2} Δ {lE}_{Y} + {P}_{IH} {l}_{0} ) \qquad ( 6 )$$

wherein, J_{IH} is the J-integral value of HIC, a unit is kJ/m², wherein r₀ is an original radius of the specimen, a unit is m; E_{Y} is the elastic modulus of material, a unit is MPa and P_{IH} is the critical load of HIC.

A calculation formula of the second geometric function is:

$${F}_{2} = \frac{( {l}_{0} + Δ l ) Δ l}{{l}_{0}^{2} {r}^{2}} \qquad ( 7 )$$

wherein, F₂ is the geometric function under the elastoplastic crack growth mechanism, a unit is m⁻², wherein r is a notch radius of the notched round bar tensile specimen, a unit is m and Δl is the first maximum displacement.

In the two mechanisms of the step S3, the specific steps of obtaining the critical load of HIC include:
S301: obtaining a true strain and a true stress of the notched round bar tensile specimen using the engineering stress and the engineering strain;
S302: plotting a true stress-true strain curve based on the true strain and true stress to fit the test data; and
S303: obtaining an actual strain ε_{T0} corresponding to a strain hardening rate of 0 based on the fitted test data, and taking a load corresponding to the actual strain ε_{T0} as the critical load of HIC.

In the step S301, a formula of the obtained true stress is:

$${σ}_{T} = σ ( 1 + ε ) \qquad ( 8 )$$

wherein, σ is the engineering stress, ε is the engineering strain and σ_{T} is the true stress; and
a formula of the obtained true strain is:

$${ε}_{T} = ln ( 1 + ε ) \qquad ( 9 )$$

wherein ε_{T} is the true strain.

In the step S302, the test data is fitted to a fifth-order polynomial. Specifically, a true stress-true strain curve is plotted using origin software, and then the polynomial fitting is performed on the experimental data, wherein the degree of the fitted polynomial is 5.

In the step S303, a method of obtaining the actual strain ε_{T0} is: differentiating the fitted test data and plotting a θ-ε_{T} curve using the origin software, wherein a strain hardening rate θ=dσ_{T}/dε_{T}, the actual strain at the strain hardening rate θ=0 is ε_{T0}, and a load corresponding to the ε_{T0} is taken as the critical load P_{IH} of HIC, a unit is kN.

In a more preferred embodiment, the steps S1-S3 are repeated at least three times to obtain at least three sets of the HIC threshold values. The average of these multiple HIC threshold values is then taken as the final HIC threshold value.

The following comparative tests are performed respectively using the testing method of the disclosure and the traditional compliance unloading testing method with X65 pipeline steel as the testing subject.

The processing drawing of the X65 pipeline steel specimen is shown in FIG. 2. The yield strength of the welded joints is 464 MPa, the tensile strength is 540 MPa, and multiple specimens are obtained.

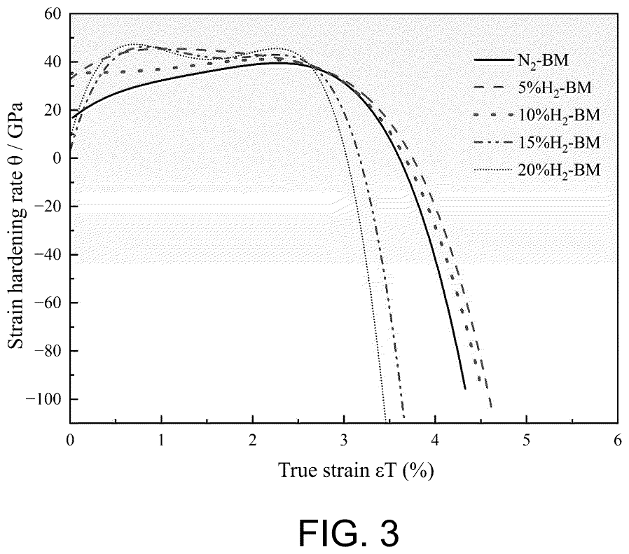

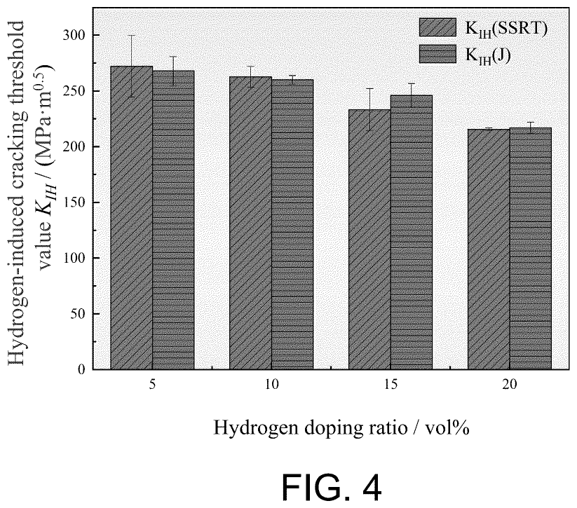

The corresponding specimens are performed the tests respectively using the traditional compliance unloading testing method and the slow strain rate tensile (SSRT) method under five different atmospheric environments at a ambient temperature of 25° C. The HIC threshold values K_{IH(J)} under the traditional compliance unloading testing method and the HIC threshold values K_{IH(SSRT)} under the SSRT method of the disclosure are obtained respectively. The aforementioned atmospheric environments are pure N₂ atmosphere and four mixed atmospheres of N₂ and H₂ with different component ratios, wherein the hydrogen doping ratios I_{HE} of the mixed atmospheres are respectively 5%, 10%, 15% and 20%. When performing the SSRT tests on the specimens, at least three repeated tests are performed in each kinds of the environments, and the testing results are shown in Table 1, FIG. 3 and FIG. 4.

TABLE 1
The testing results of the HIC threshold value K_{IH}

| | Elastoplastic | | K_{IH(SSRT)}/ | K_{IH(J)}/ |
|---|---|---|---|---|
| Environment | parameter R | I_{HE}/% | MPa · m^{0.5} | MPa · m^{0.5} |
| 5% H₂ | 1.5 | 3.7 | 272.2 ± 27.6 | 267.9 ± 13.0 |
| 10% H₂ | 1.6 | 6.0 | 262.7 ± 9.5 | 260.0 ± 4.0 |
| 15% H₂ | 2.0 | 12.1 | 233.2 ± 18.9 | 246.0 ± 10.7 |
| 20% H₂ | 2.1 | 15.2 | 215.7 ± 1.3 | 216.9 ± 5.1 |

FIG. 3 shows the θ-ε_{T} curve obtained using the testing method of the disclosure, in which the true strain corresponding to the strain hardening rate of 0 is obtained, and the load corresponding to the true strain at this time is taken as the critical load of HIC. Using the above calculation process, the HIC threshold values K_{IH(SSRT)} under different hydrogen doping ratio environments are obtained. Combined with Table 1 and FIG. 4, it can be seen that the HIC threshold values obtained using the testing method of the disclosure are close to the results obtained by the conventional compliance unloading testing method, which proves the accuracy of the testing method of the disclosure and can replace the conventional testing method to efficiently obtain the HIC threshold values.

Another embodiment of the disclosure further provides a testing system for implementing any one of the aforementioned testing methods. The testing system comprises:
a test data acquisition module, configured to obtain test data after performing the SSRT test on the notched round bar tensile specimen in the hydrogen environment, the test data including the yield strength, the tensile strength, the first maximum displacement, the engineering stress and the engineering strain, and configured to obtain the first elongation rate using the first maximum displacement and the original length of the notched round bar tensile specimen; and further configured to obtain the corresponding second maximum displacement after performing the SSRT test on the same notched round bar tensile specimen in the inert gas environment, and obtain the second elongation rate using the second maximum displacement and the original length; and
a specimen parameter acquisition module, configured to obtain the hydrogen embrittlement susceptibility index of material using the first elongation rate and the second elongation rate; and obtain the elastoplastic parameter R using the hydrogen embrittlement susceptibility index of material, the yield strength and the tensile strength; and
a HIC threshold value acquisition module, configured to obtain the HIC threshold value using a linear elastic crack growth mechanism when the elastoplastic parameter R is not greater than 3.5; and configured to obtain the HIC threshold value using a elastoplastic crack growth mechanism when the elastoplastic parameter R is greater than 3.5.

It can be understood that the detailed functional implementation of the above units/modules can refer to the introduction in the aforementioned method embodiments, and will not be described in detail herein.

It should be understood that the above system is used to execute the method in the above embodiments, and the corresponding program modules in the apparatus have similar implementation principles and technical effects as described in the above method. The working process of the apparatus can refer to the corresponding process in the above method, and will not be described in detail herein.

Based on the method in the above embodiments, the embodiments of the disclosure provide an electronic apparatus. The apparatus may include: at least one memory for storing a program and at least one processor for executing the program stored in the memory. Among them, when the program stored in the memory is executed, the processor is configured to execute the method described in the above embodiments.

Based on the method in the above embodiments, the embodiments of the disclosure provide a computer-readable storage medium. The computer-readable storage medium stores a computer program, and when the computer program runs on a processor, the processor is caused to execute the method in the above embodiments.

Based on the method in the above embodiments, the embodiments of the disclosure provide a computer program product that, when the computer program product runs on a processor, the processor is caused to execute the method in the above embodiments.

It can be understood that the processor in the embodiments of the disclosure may be a central processing unit (CPU), and may also be other general-purpose processors, digital signal processors (DSP), application specific integrated circuits (ASIC), field programmable gate arrays (FPGA) or other programmable logic devices, transistor logic devices, hardware components or any combination thereof. The general-purpose processors may be a microprocessor, or may be any conventional processors.

The method steps in the embodiments of the disclosure may be implemented by hardware, or may be implemented by a processor executing software instructions. The software instructions may be composed of the corresponding software modules, and the software modules may be stored in random access memory (RAM), flash memory, read-only memory (ROM), programmable ROM (PROM), erasable PROM (EPROM), electrically EPROM (EEPROM), registers, hard disk, removable hard disk, CD-ROM or any other form of the storage medium known in the art. An exemplary storage medium is coupled to the processor such that the processor can read information from the storage medium and can write information to the storage medium. Of course, the storage medium may also be a component of the processor. The processor and the storage medium may be located in the ASIC.

In the above embodiments, implementation may be achieved entirely or partially through software, hardware, firmware or any combination thereof. When implemented using software, it may be implemented entirely or partially in the form of a computer program product. The computer program product includes one or more computer instructions. When the computer program instructions are loaded and executed on a computer, the processes or functions according to the embodiments of the disclosure are generated entirely or partially. The computer may be a general-purpose computer, a special-purpose computer, a computer network or other programmable device. The computer instructions may be stored in a computer-readable storage medium or transmitted through a computer-readable storage medium. The computer instructions may be transmitted from one website, computer, server or data center to another website, computer, server or data center through the form of wired (e.g., coaxial cable, optical fiber, digital subscriber line (DSL)) or wireless (e.g., infrared, radio, microwave, etc.). The computer-readable storage medium may be any available medium or a data storage apparatus including one or more of a server with available media integrations, a data center, etc. that can be accessed by a computer. The available medium may be magnetic media (e.g., floppy disk, hard disk, and magnetic tape), optical media (e.g., DVD) or semiconductor media (e.g., solid state disk (SSD)), etc.

It can be understood that the various numerical designations involved in the embodiments of the disclosure are merely for convenient distinction and description, and are not used to limit the scope of the embodiments of the disclosure.

Those skilled in the art can easily understand that the above description is only preferred embodiments of the disclosure and is not intended to limit the disclosure. Any modifications, equivalent substitutions, and improvements made within the spirit and principle of the disclosure should be included within the scope of the disclosure.

What is claimed is:

1. A testing method for a hydrogen-induced cracking threshold value based on a notched round bar tensile specimen, comprising:
S1: performing a slow strain rate tensile test on the notched round bar tensile specimen in a hydrogen environment to obtain test data, the test data including a yield strength, a tensile strength, a first maximum displacement, an engineering stress and an engineering strain, obtaining a first elongation rate using the first maximum displacement and an original length of the notched round bar tensile specimen; performing the slow strain rate tensile test on the same notched round bar tensile specimen in an inert gas environment to obtain a second maximum displacement, and obtaining a second elongation rate using the second maximum displacement and the original length;
S2: obtaining a hydrogen embrittlement susceptibility index of material using the first elongation rate and the second elongation rate; and obtaining an elastoplastic parameter R using the hydrogen embrittlement susceptibility index of material, the yield strength and the tensile strength, a formula of the obtained elastoplastic parameter R expressed as:
$$R = 6.32 {I}_{HE} + \frac{{σ}_{NTS}}{{σ}_{y}}$$
wherein, R is the elastoplastic parameter, σ_{y} is the yield strength, σ_{NTS} is the tensile strength and I_{HE} is the hydrogen embrittlement susceptibility index of material;
S3: determining whether the elastoplastic parameter R is greater than 3.5,
if yes, obtaining the corresponding hydrogen-induced cracking threshold value using the following formula:
$${K}_{IH} = \sqrt{\frac{{J}_{IH} {E}_{Y}}{( 1 - {v}^{2} )}}$$
wherein, K_{IH} is the hydrogen-induced cracking threshold value, a unit is MPa·m^{0.5}, J_{IH} is a J-integral value of hydrogen-induced cracking, E_{Y} is an elastic modulus of material and ν is a Poisson's ratio;
if no, obtaining the corresponding hydrogen-induced cracking threshold value using the following formula:
$${K}_{IH} = {P}_{IH} {D}^{0.5} {F}_{1}^{0.5}$$
wherein, K_{IH} is the hydrogen-induced cracking threshold value, a unit is MPa·m^{0.5}, P_{IH} is a critical load of hydrogen-induced cracking, D is an original diameter of the notched round bar tensile specimen and F1 is a first geometric function under a linear elastic crack growth mechanism.

2. The testing method for the hydrogen-induced cracking threshold value based on the notched round bar tensile specimen according to claim 1, wherein in the step S2, a formula of the obtained hydrogen embrittlement susceptibility index of material is expressed as:
$${I}_{HE} = \frac{{δ}_{0} - {δ}_{H}}{{δ}_{0}}$$
wherein, I_{HE} is the hydrogen embrittlement susceptibility index of material, δ_{H} is the first elongation rate and δ₀ is the second elongation rate.

3. The testing method for the hydrogen-induced cracking threshold value based on the notched round bar tensile specimen according to claim 1, wherein a notch stress concentration factor of the notched round bar tensile specimen is 3 or greater.

4. The testing method for the hydrogen-induced cracking threshold value based on the notched round bar tensile specimen according to claim 1, wherein the first geometric function is obtained by the following formula:
$${F}_{1} = 22.5 ( \frac{{d}^{2}}{{D}^{4}} ) ( 1 - \frac{d}{D} ) + 3.86 ( \frac{D}{{d}^{3}} ) {( 1 - \frac{d}{D} )}^{2}$$
wherein, D is the original diameter of the notched round bar tensile specimen; and d is a notch diameter of the notched round bar tensile specimen.

5. The testing method for the hydrogen-induced cracking threshold value based on the notched round bar tensile specimen according to claim 1, wherein a calculation formula of the J-integral value of hydrogen-induced cracking is:
$${J}_{IH} = 0.0021 {F}_{2} ( π {r}_{0}^{2} Δ {lE}_{Y} + {P}_{IH} {l}_{0} )$$
wherein, J_{IH} is the J-integral value of hydrogen-induced cracking, l₀ is the original length of the notched round bar tensile specimen, r₀ is an original radius of the notched round bar tensile specimen, F₂ is a second geometric function, P_{IH} is the critical load of hydrogen-induced cracking and Δl is the first maximum displacement.

6. The testing method for the hydrogen-induced cracking threshold value based on the notched round bar tensile specimen according to claim 5, wherein a calculation formula of the second geometric function is:
$${F}_{2} = \frac{( {l}_{0} + Δ l ) Δ l}{{l}_{0}^{2} {r}^{2}}$$
wherein, F₂ is the second geometric function under an elastoplastic crack growth mechanism, wherein r is a notch radius of the notched round bar tensile specimen.

7. The testing method for the hydrogen-induced cracking threshold value based on the notched round bar tensile specimen according to claim 1, wherein steps of obtaining the critical load P_{IH} of hydrogen-induced cracking comprise:
S301: obtaining a true strain and a true stress of the notched round bar tensile specimen using the engineering stress and the engineering strain;
S302: plotting a true stress-true strain curve based on the true strain and true stress to fit the test data; and
S303: obtaining an actual strain ε_{T0} corresponding to a strain hardening rate of 0 based on the fitted test data, and taking a load corresponding to the actual strain ε_{T0} as the critical load P_{IH} of hydrogen-induced cracking.

8. The testing method for the hydrogen-induced cracking threshold value based on the notched round bar tensile specimen according to claim 7, wherein in the step S301, a formula of the obtained true stress is:
$${σ}_{T} = σ ( 1 + ε )$$
wherein, σ is the engineering stress, ε is the engineering strain and σ_{T} is the true stress;
a formula of the obtained true strain is:
$${ε}_{T} = ln ( 1 + ε )$$
wherein ε_{T} is the true strain.

9. The testing method for the hydrogen-induced cracking threshold value based on notched round bar tensile specimen according to claim 7, wherein in the step S302, the test data is fitted to a fifth-order polynomial.

10. The testing method for the hydrogen-induced cracking threshold value based on the notched round bar tensile specimen according to claim 7, wherein in the step S303, a method of obtaining the actual strain ε_{T0} is:
differentiating the fitted test data and plotting a θ-ε_{T} curve, wherein θ=dσ_{T}/dε_{T}, a strain at the strain hardening rate θ=0 as the true strain ε_{T0}.

11. A testing system, configured to implement the testing method according to claim 1, the testing system comprising:
a test data acquisition module, configured to obtain test data after performing the slow strain rate tensile test on the notched round bar tensile specimen in the hydrogen environment, the test data including the yield strength, the tensile strength, the first maximum displacement, the engineering stress and the engineering strain, and configured to obtain the first elongation rate using the first maximum displacement and the original length of the notched round bar tensile specimen; and configured to obtain the corresponding second maximum displacement after performing the slow strain rate tensile test on the same notched round bar tensile specimen in the inert gas environment, and obtain the second elongation rate using the second maximum displacement and the original length;
a specimen parameter acquisition module, configured to obtain the hydrogen embrittlement susceptibility index of material using the first elongation rate and the second elongation rate; and obtain the elastoplastic parameter R using the hydrogen embrittlement susceptibility index of material, the yield strength and the tensile strength; and
a hydrogen-induced cracking threshold value acquisition module, configured to determine whether the elastoplastic parameter R is greater than 3.5,
if yes, further configured to obtain the hydrogen-induced cracking threshold value based on an elastoplastic crack growth mechanism; and
if no, further configured to obtain the hydrogen-induced cracking threshold value based on a linear elastic crack growth mechanism.
